(19) United States
(12) Patent Application Publication
(10) Pub. No.: US 2002/0111885 A1
(43) Pub. Date: Aug. 15, 2002

(54) Commercial data registry system

(76) Inventors: Frederick J. Geiger, Washington Crossing, PA (US); Michael Klybor, Annapolis, MD (US)

Correspondence Address: DANN DORFMAN HERRELL & SKILLMAN, SUITE 720, 1601 MARKET STREET, PHILADELPHIA, PA, 19103-2307, US

(21) Appl. No.: 10/059,049

(22) Filed: Jan. 28, 2002

Related U.S. Application Data
(63) Continuation-in-part of application No. 09/753,068, filed on Dec. 29, 2000.

(51) Int. Cl. G06F 17/60

(52) U.S. Cl. 705/28; 705/34

(57) ABSTRACT

A commercial data registry system provides a database connected to a computer network allow access to an authoritative repository of records relating to goods and services. Trading partners may subscribe to receive updated commercial data pertaining to goods or services in which they presently deal and/or goods or services of potential interest to them. Integration of registry operations with existing electronic commerce procedures provides continuously valid data to facilitate business to business transactions.

### CROSS-REFERENCE TO RELATED APPLICATION

This application is a Continuation-In-Part of U.S. Patent application Ser. No. 09/753,068, filed Dec. 29, 2000.

### FIELD OF THE INVENTION

The present invention relates to a registry system for maintaining authoritative data on goods and services in commerce, and for providing an electronic data exchange system among trading partners.

### BACKGROUND OF THE INVENTION

Efficiently matching the capabilities of suppliers with customers is the essence of commerce. Given the large variety of commercial goods and services available from suppliers in the modem economy, and the similarly diverse needs among retailers and other participants in the distribution chain, it can be difficult to locate effective matches among trading partners. It can also be difficult for trading partners to maintain efficient relationships when new products are introduced or when specifications of existing products are changed (and, conversely, when demand specifications are changed). A grocery store chain, for example, must manage thousands of individual trading relationships with partners in many different locations. A supply partner at the other end of one of those relationships may also be tasked with managing thousands of other relationships with retailers. Each of these relationships may involve keeping track of the locations of a large number of data items provided in a variety of formats. It would thus be desirable to provide a uniform registry system by which suppliers may indicate their supply capabilities and by which demand partners may indicate their interest in particular supply capabilities. It would further be desirable to provide such a registry system which provides flexible access methods suitable to the needs of high and low volume trading partners.

### SUMMARY

In accordance with the present invention, there is provided a commercial data registry system for providing a uniform, secure, and neutral source of supplier capabilities and demand partner preferences among commercial trading partners. The registry comprises a database and a network interface for providing access to the database via several alternate methods. The database stores records of goods and services available from suppliers, locations of trading partners, and subscription records of trading partners indicating goods and services of interest to them. The network interface is configured to provide a graphical user interface to trading partners desiring to access the database manually, and the network interface is further configured to receive and process XML document transmissions for trading partners desiring high volume access. Functions provided by the registry system of the present invention include providing selective notifications to user of events of interest to them via a subscription mechanism; selective publication of new or modified supplier capabilities, goods or services; enforcement of commercial data format standards; and processing and storage facilities to providing message queues by which trading partners may communicate interest in new or modified registry data items, or responses to published registry data items.

### BRIEF DESCRIPTION OF THE DRAWINGS

The foregoing summary and the following detailed description will be best understood when read in conjunction with the appended drawings, in which:

FIG. 1 is a functional block diagram of a system architecture of a commercial data registry system in accordance with the invention;

FIG. 2 is a diagram of associations among data records stored in a registry database of FIG. 1;

FIG. 3 is a flowchart of a method of the present invention;

FIG. 4 is a view of a graphical user interface screen for establishing trading partner profile data elements for registration in the commercial data registry;

FIG. 5 is a view of a graphical user interface screen for maintaining an item record for storage in the commercial data registry;

FIG. 6 is a view of a graphical user interface for establishing and issuing a publication of a data record to the registry;

FIG. 7 is a view of a graphical user interface screen for establishing a subscription record for storage in the commercial data registry;

FIG. 8 is a view of a graphical user interface screen of a notification worklist of events of interest to a trading partner obtained from the registry;

FIG. 9 is a view of a graphical user interface screen of a detailed notification of an item from the worklist of FIG. 6;

FIG. 10 is a view of an email message notification of an item of interest to a trading partner obtained from the registry; and

FIG. 11 is a view of an XML document transmission of a notification of an item of interest to a trading partner obtained from the registry.

### DETAILED DESCRIPTION OF THE INVENTION

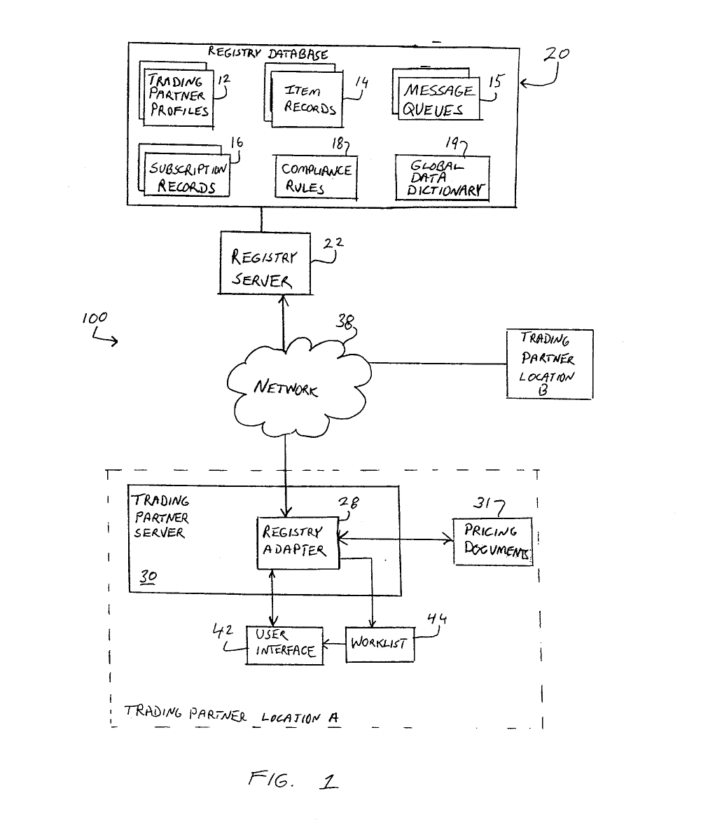

Referring to FIG. 1, a system architecture of the invention is shown. The system architecture provides an environment to support processes that are used to synchronize information among system subscribers, herein referred to as trading partners. Trading partners include supply-side partners, those that produce items, and demand-side partners, those that purchase items. The system 100 includes a registry database 20 which contains information to be exchanged among users belonging to the community of trading partners. The registry database 20 contains trading partner profiles 12 which contain information specifying the identities and structures of trading partners, item records 14 which describe commercial goods or services, subscription records 16 which define types of information users desire to receive from the registry database 20, messaging queues 15 which store messages to be exchanged among the trading partners, and a set of compliance rules 18 which define various requirements of the data content of the registry database 20.

The trading partner profiles 12 contain contact information for subscribers to the registry, which include trading partners such as supply-side partners and demand-side partners. In addition, each trading partner profile 12 contains information defining user roles and locations for each trading partner. The role information defines access control permissions for a given user. In order for a user to a perform a given function in the system, a user must have been granted permission for that function when the user record for the corresponding partner profile was defined.

Each of the item records 14 contains a Global Trade Identification Number (GTIN) unique to each product or service. Basic item data contained in an item record 14 may include descriptive information, date of availability, dimensions, order increment, and other miscellaneous information. The basic descriptive information includes a product type, product code, unit description, category, and brand to provide a basic description of the item. The product type, product code and category information may be based on a predefined lexicon of terms. For example, the product type and code may be selected from terms of the EAN (European Article Number) or UCC (Uniform Code Council) standards, and the category information is preferably a numerical classification system associating categories of goods or services in commerce with a classification number. Since a particular item may be available on a seasonal or temporary basis, the product item records 14 may include date of availability information. Physical dimensions and weight may also be specified for item records 14 corresponding to goods. A supply-side user may also specify minimum, maximum, or increment order limits as part of the product item records 14. Further information such as special handling codes, colors, and hazardous material data, may be included within an product item record 14.

The subscription records 16 are defined by users desiring notification of specific types of information from the registry database 20 as well as notification and delivery of such information as it is added to, or maintained in, the registry database 20. A subscription may include requests for information regarding specific items, trading partner organizations, users, or other information maintained within the registry database. For example, a subscription may contain a user's request to receive selected notifications about particular items. The particular subscription can be defined, for example, in terms of a category classification or a specific GTIN item identifier. The subscription may further specify selected notifications be delivered, such as notifications of new items only, deletions only, or all changes respecting the particular item. Alternatively, a subscription may contain a request for information regarding trading partners, Global Location, Numbers, or product categories rather than specific items.

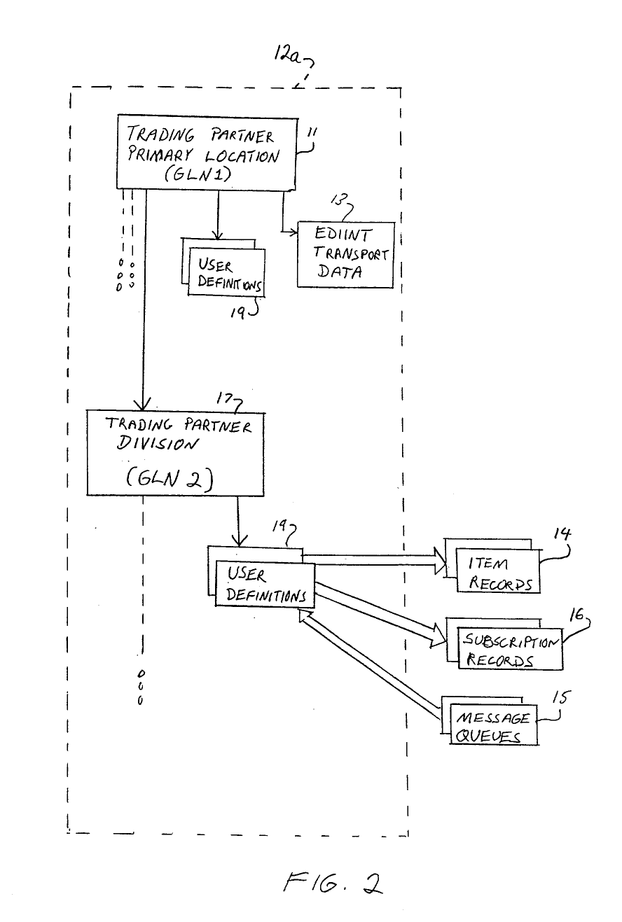

The trading partner profiles 12, item records, subscription records 16, messaging queues 15 and other data, are associated within the registry database as shown in FIG. 2. A trading partner profile, such as profile 12a, is a hierarchical set of records reflecting the organizational structure of the trading partner. A unique identification number, herein referred to as a Global Location Number (GLN) is assigned to each organizational unit corresponding to a node of the organizational hierarchy of the trading partner. At the highest level 11 of the profile is the identity of the trading partner and a primary location, such as the partner's headquarters, which is assigned a GLN (e.g. GLN 1).

Associated with the trading partner, there may be certification data 13 in accordance with the Electronic Data Interchange over Internet (EDIINT) standard. The EDIINT standard, as described in successive draft documents published by the Internet Engineering Task Force, describes a protocol for conducting secure encrypted commercial transactions over the Internet. In order to establish and conduct EDIINT transactions, the respective parties must mutually exchange transport data, such as Internet protocol addresses, and encryption data, such as public keys. Associating the requisite EDIINT data in a standard format with the trading partner profile provides users of the present system with an authoritative repository of EDIINT data, for those partners desiring to enter into commercial transactions via EDIINT on the basis of data exchanged via the system.

Successive subordinate organizational units, such as divisions, distribution centers and the like (or, in the case of a demand-side partner, retailing locations and the like) are each assigned a unique GLN. In FIG. 2, there is shown a representative division 17, having GLN 2. The geographical location corresponding to a GLN may be the same as, for example, where different functional units of the trading partner are located at a single geographic location. Hence, while each GLN is unique to a functional unit of the trading partner organization, respective GLN's may correspond to the same geographic location.

At each unit in the trading partner organization, there may be defined one or more users records 19 corresponding to individual users. Multiple users may be defined within each trading partner organization, so that individuals within a demand-side organization having separate areas of trading responsibility may define subscriptions 16 pertaining to their area of responsibility. Hence, the subscription records 16 may be associated with one or more. For example, a retailer may define individual managers responsible for various departments within a retail establishment, and those users are assigned roles which permit them to establish and maintain subscription records 16 pertaining to the relevant classifications of goods or services. In a supply-side organization, user roles may be defined to allow users to establish and maintain item records 14 corresponding to classifications for which they are responsible. Messages to be exchanged within the system, as described further herein, are stored in message queues 15 corresponding to each user.

Referring again to FIG. 1, the system 100 includes a registry server 22 for controlling the flow of information to and from the registry database 20 and a data communications network 38. Users communicate with the registry database 20 via a trading partner server 30 connected to the data communications network 38.

The trading partner server 30 implements a registry adapter 28 which includes a user interface 42 and a notification queue, or worklist 44. The worklist 44 receives and maintains a list of notifications delivered by the registry database 20 to the registry adapter 28. Such notifications contain data from the registry database 20 which are retrieved from the users messaging queues. These notifications may be received, for example, in response to a user's requests present in one or more subscription records 16, or in response to prior messages sent, as described further below. The notifications are provided to users who subscribe to receive information when events of interest occur, such as the addition or updating of selected types of information within the registry database 20, in accordance with the user's subscription records.

A user may access the worklists 44 using the user interface 42. The user interface 42 is further configured to enable the user to enter subscription requests, user information, item information, to be uploaded to the registry database 20. The user interface may comprise, for example, one or more inter-operating Java applets arranged to interpret and present raw XML documents communicated within the system 100 into a human-readable format.

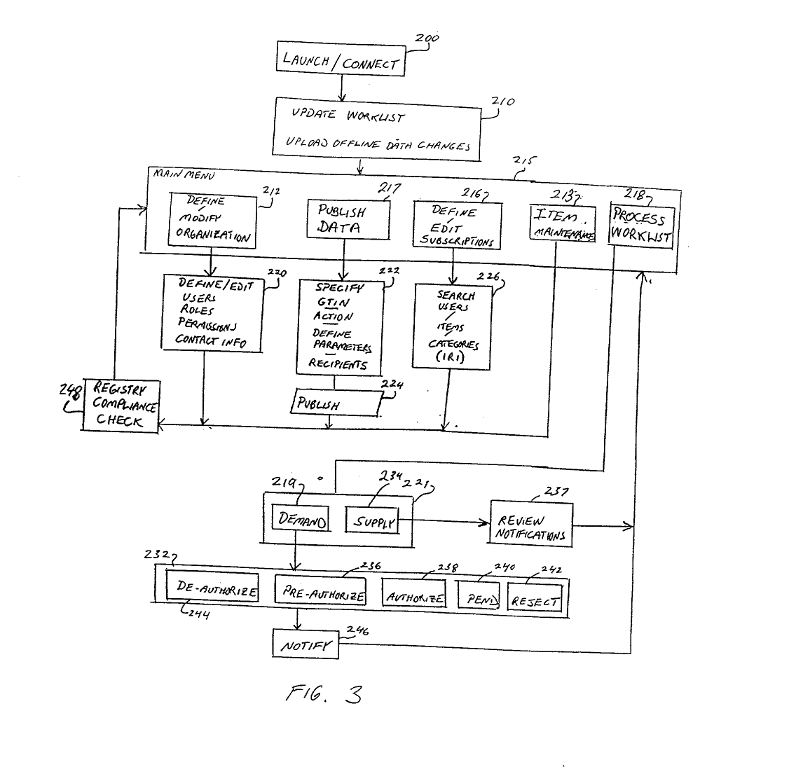

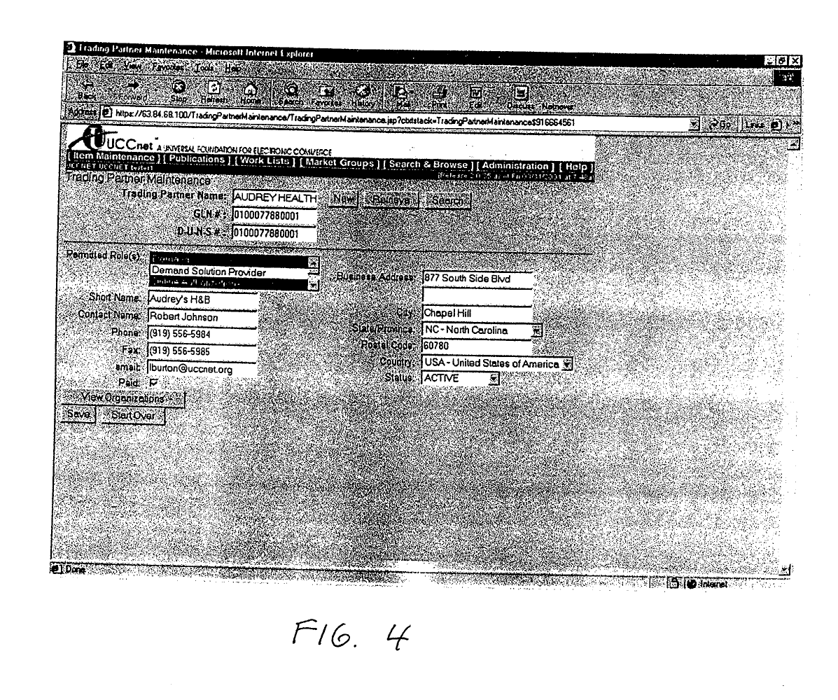

FIG. 3 illustrates various functions provided by the registry adapter 28. To initiate use of the system by a trading partner, a connection is made between the trading partner server and the registry database, at step 200. When a connection is made, the registry transmits notifications in accordance with messages stored in the user's messaging queue. Upon receipt of this information, the trading partner server updates the status of the notification in the worklist, at step 210. The registry database maintains a list of all known registry adapters, the date of their last update, and the subscription records pertaining to each user. As new or altered information is added to the registry database, the registry server places messages into the appropriate message queues on a regular schedule.

Having updated and synchronized the trading partner server to the registry database, the user may proceed to perform one or more of the functions depicted in block 215. The user's ability to perform any of the operating functions depends on the user's role and access permissions. In order for a user to a perform a given function in the system, a user must have been granted access control permission for that function. Depending on a user's role she may have permission to merely view and not alter information, for example.

Organizational information can be defined or modified by selection option 212 from block 215. In order to create or modify a trading partner profile, an assigned trading partner system administrator defines and modifies an organizational structure of users at step 212. For example, as shown in the initial partner profile definition screen of FIG. 3, the administrator may establish the name of the trading partner, and define the trading partner's users at step 220. Definition of the user begins with establishing a user ID which is unique among all users of the trading partner community. The user ID is associated with the organization as part of the user ID record. The user ID record also includes contact information for the user and the role of the user.

For each user defined, the administrator may establish permitted roles. A role is a logical grouping of one or more permissions. Roles typically correspond to job functions. The system includes certain predefined roles, such as trading partner system administrator, user administrator, category manager, or general user. A general user role grants access control permission to search/browse all items and to view information such as categories, other trading partner descriptions, authorizations for products available to their organization, publication requests targeted to their organization, and data subscriptions for their organization. Further roles may grant access control permissions that depend on whether the role is assigned to a supply-side user or a demand-side user. For example, a supply-side trading partner administrator role grants permission to perform the function of item maintenance, step 214, described below. The category manager role corresponds to a job function that is specific to a demand-side user. The category manager role grants permission to authorize, de-authorize, pre-authorize, reject, or pend an item, as described in association with steps 236-246 below.

The system administrator for a trading partner may also define the method of access to the registry which will be employed by that trading partner, or by users within the trading partner organization. The registry system is configured to allow different methods of access in accordance with user preferences. For example, the registry may provide GUI access to the system functions described below and provided by the registry server via a “thin” client, such as a browser; the registry may provide for processing of messages to be delivered via email; or the registry may communicate with the trading partner server directly via XML messages. GUI access may be preferred by relatively low volume subscribers desiring to manually perform the various functions described herein, while direct XML messaging may be preferred by high-volume subscribers who desire to configure their servers to automatically format and process the functions described herein and/or to communicate with their pre-existing internal data management systems. Hence, it will be appreciated that the functions described herein are capable of being performed manually by a graphical interface to the registry system, automatically by an XML messaging system, or on a hybrid basis in which the trading partner provides its own custom user interface to an XML message processing system.

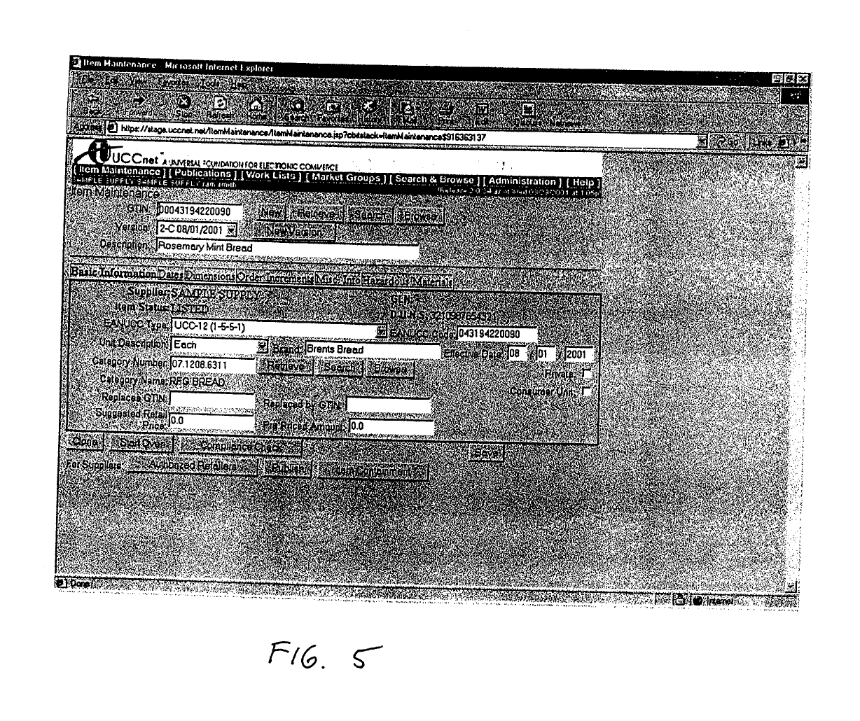

A second option provided at block 215 is item maintenance, shown therein as menu option 213. Item maintenance is performed by a supply-side trading user(s) responsible for an item. Item maintenance is performed to update basic information stored in existing item records associated with a GTIN, and to indicate whether an item record replaces, or is replaced by, another GTIN. As shown in FIG. 5, such information may include a basic description of the item, its category, unit description, brand, EAN/JUCC code, and the effective date of the item record. The user may also edit an existing item as part of item maintenance to indicate that the existing item is being replaced by a new item. In this case, the supply-user enters a “replaced by” attribute in the existing item that points to the new item.

After specifying the appropriate data at step 213, the new or modified item record is checked for compliance with the compliance rules at step 248. These changes, however, are subject to restrictions imposed by the compliance rules. Once a item has been entered into the registry database, the rules prohibit altering selected attributes that define the item. For example, if the item is defined to have a particular net weight, changing its weight attribute would not be permitted by the rules. Under this scenario, the net weight of an item is deemed to be a defining attribute of the item. Denying such a change prevents a demand-side user who has come to associate a particular GTIN item identifier with a particular weight from receiving a different weight by mistake.

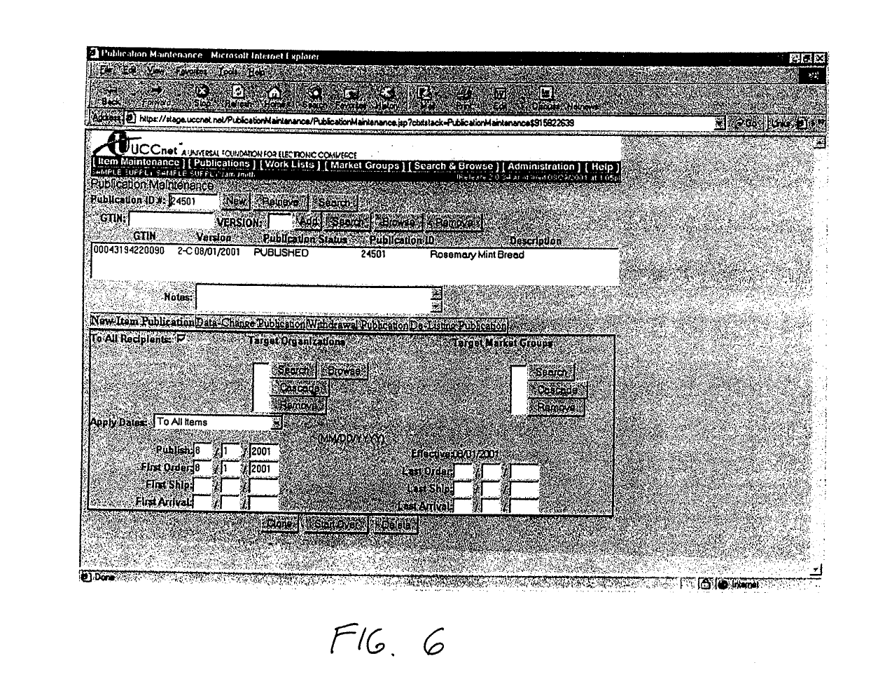

Another option provided at block 215 is to establish publications, shown as option 217. A publication is a directed notification of the existence of a new item record, or a change to an existing record. The process of publishing a new item entails creation and entry of a GTIN item identifier unique to that item and the entry of additional attributes defining the item, shown at step 213. Examples of attributes include category information, brand, unit descriptors, data availability, dimensions, order increments, and other attributes as described above. A sample graphical interface user screen for publication maintenance is shown in FIG. 6. As can be seen therein, a supply-side trading partner may specify whether a publication indicates a new item, a data change to an existing item, a withdrawal of a publication, or a de-listing of an item. Provisions are also made for linking items to indicate that a item is contained within another item.

All the information entered by the supply-side trading partner administrator, for both new items and changes to existing items at step 222, are verified in a compliance checking step, step 248. Compliance checking uses accepted standards, such as those defined in the rules of the registry database, to validate the item information. For XML transmissions, the received XML documents are compared with a predetermined document type definition established at the registry. The basic checks performed on an attribute-by-attribute basis include ensuring that the numerical fields are numeric, that lengths are not exceeded, that value lists are enforced (e.g., that the unit of measurement attribute contains one of the valid codes), and that the minimum/maximum values are numeric fields. Beyond the basic checks, there are more advanced checks that rely on the business logic and specific fields. For example, there are numerous detailed validations that occur on the GTIN item identifier such as verifying a checksum digit and ensuring that the prefix of the GTIN item identifier is valid for the user publishing the item.

Date attributes are subjected to a variety of validations such as confirming that the “first ship dates” are not earlier than the “first order dates.” Some validations depend on the data entered. For example if an “order increments” is entered then a “unit of measure” must be supplied for it.

The graphical user interface is preferably designed to provide feedback on each attribute as it is entered. In the case of an XML messaging subscriber, messages received by the registry are checked upon receipt. The system is designed to allow most items to be stored in the registry database, but not published to the community if they fail validation. A more rigorous set of validations are performed when the item is published. This approach facilitates a supply-side user's workflow, since a item can be set up with available information and supplemented as additional information becomes available before the item is published to the larger community. Another level of compliance checking is provided through audit trails that are built into the system. These provide “non-repudiation” so trading partners can confirm the details and timing of offers. To facilitate development of partner systems that are compliant with the requirements, a local compliance checking option is provided as part of step 248. Local compliance checking allows users to run validations on their own application without a connection to the registry database.

As part of the publication step 222, the supply-side trading partner administrator may specify which demand-side trading partners may receive notification of the associated item. Such selective notification permits the supply-side trading partner to specify the markets it wishes to serve. For example, the supply-side trading partner may wish to limit the market to a geographic region, only retailers, only wholesalers, or to trading partners whose profile information indicates that they are involved in a specified market group. Conversely, a supply-side trading partner administrator may “withdraw” an item and from a particular demand-side trading partner, so that the demand-side trading partner no longer receives notifications respecting that product. Additionally, delivery of notices by publication is further limited to those demand-side trading partners who have subscribed to the type of information contained within a particular publication. This prevents demand-side trading partners from receiving notifications about products in which they have no interest.

The next option provided in option block 215 is defining subscriptions. A demand-side or supply-side user may enter a subscription request, at step 216. A subscription request indicates that the user is interested in receiving a notification about selected items or other system information. Primarily subscriptions are used to receive information about items. However, a user may enter subscription to be informed when a new trading partner enters the system, especially a trading partner who supplies or purchases products of interest to the subscribing user. The process for creating a trading partner subscription is analogous to the process for creating an item subscription.

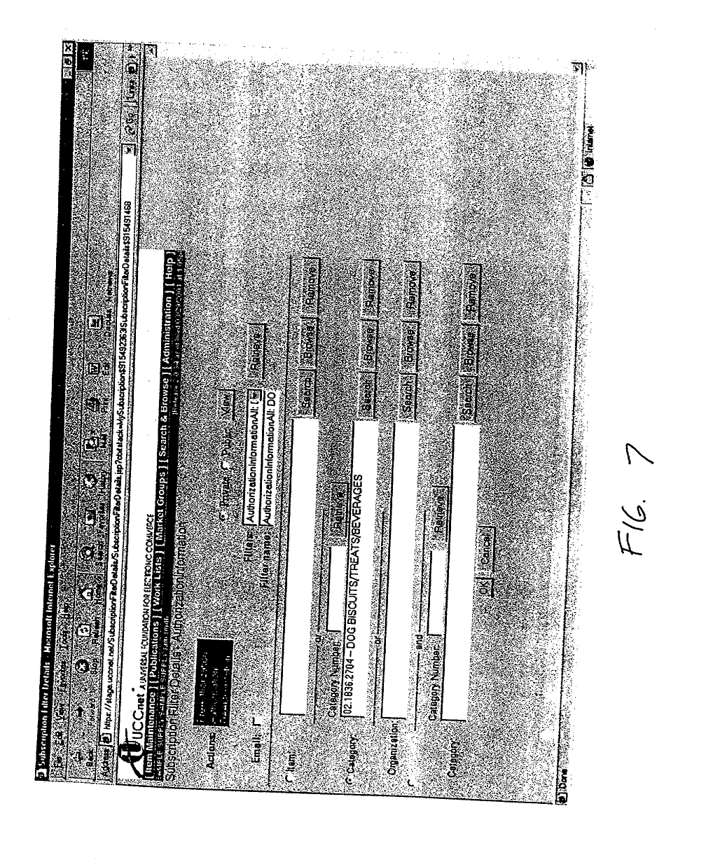

An exemplary GUI screen for defining a subscription is shown in FIG. 7. Creation of a subscription begins with the user searching for item related records of the registry database for particular item of interest, at step 226. After identifying the item information in which the demand-side user is interested, the demand-side user publishes the subscription request to the registry database as a subscription record. The publication includes the steps of updating and compliance checking the subscription request prior to its posting to the registry database, at step 248. Subscription requests may be created via access to a graphical user interface utility, or by direct XML messages sent to the registry.

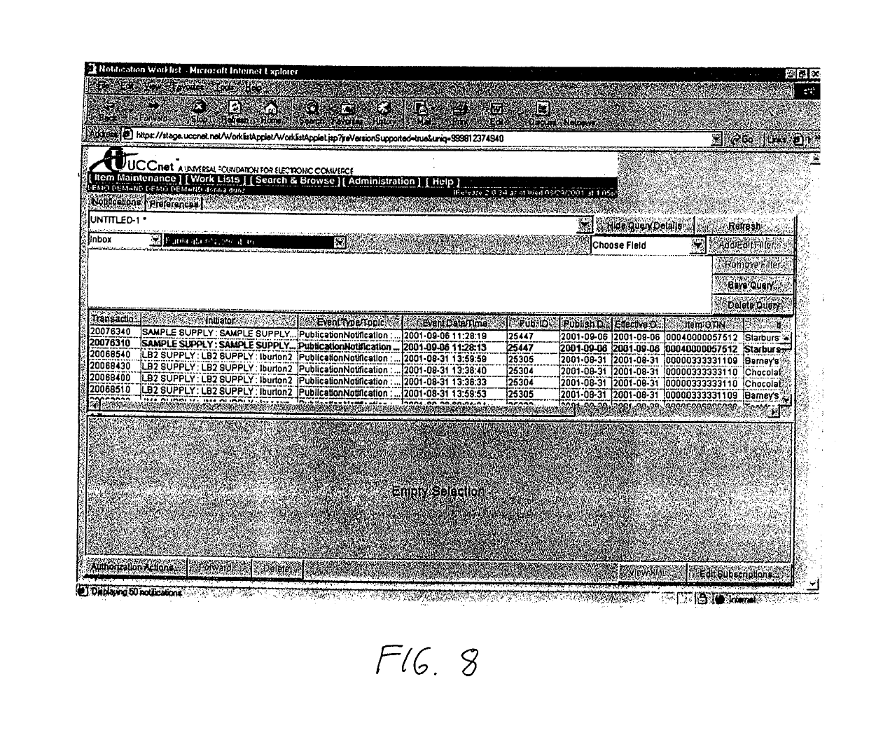

Notifications delivered pursuant to subscription records are managed by users via work lists. A user processes a work list, at step 218, to manage his outstanding tasks. The work lists may be modeled after e-mail in baskets and provide a mechanism that allows users to prioritize their work as well as to follow upon outstanding issues. Notifications can be received from the user's message queue via the system's graphical user interface, through e-mail, or through a batch XML message. The graphical user interface provides the user with selections based on message type and provides the ability to scroll through the work list of outstanding messages defined as those of interest, as shown in FIG. 8.

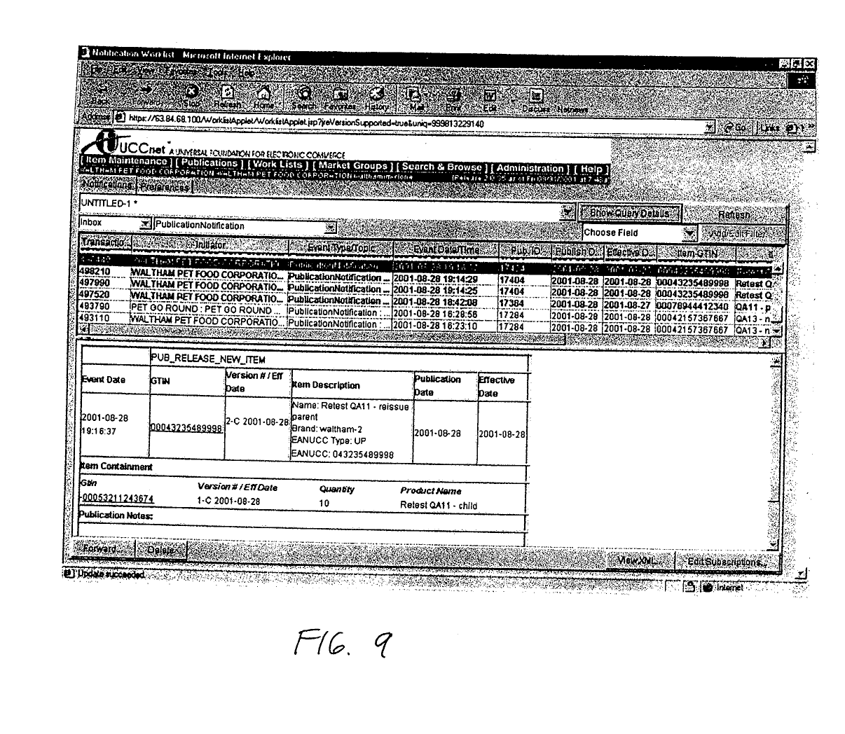

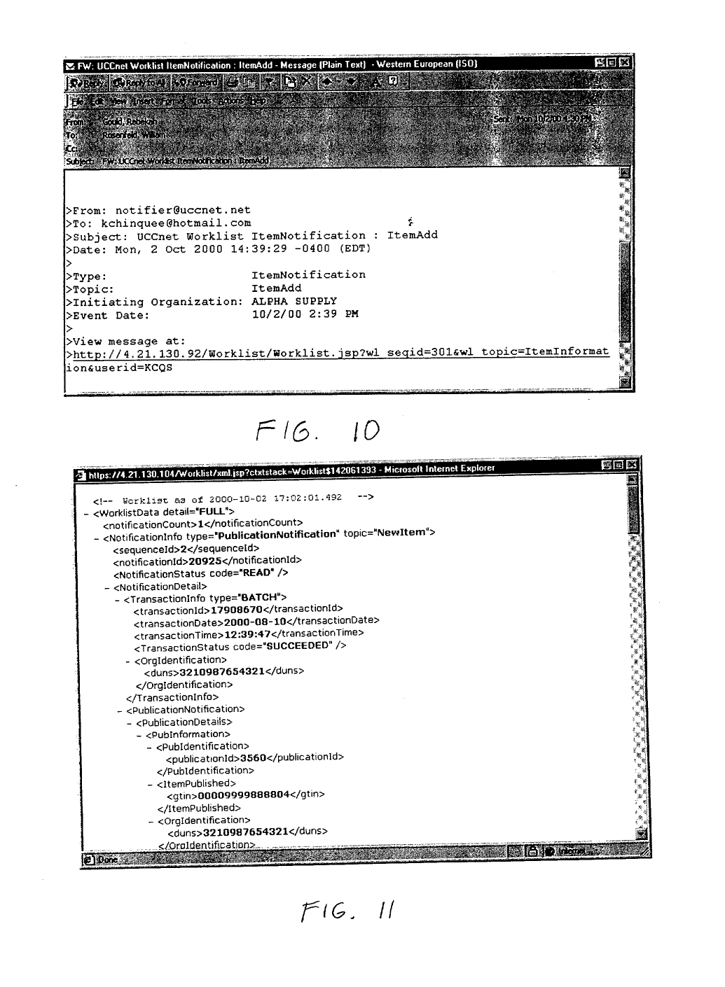

Based on the summary information displayed by the graphical user interface, the user can drill down to view the details contained within the notification, as shown in FIG. 9. This provides additional details about the item being updated, for example for a item notification, such as effective dates, and provides links for further item detail and for authorization actions. As noted above, users who do not plan to regularly use the graphical user interface may elect to receive notifications via email. Notification email messages contain an active link to appropriate screens by which the user may perform the authorization maintenance steps described below. A sample email notification message is shown in FIG. 10. For trading partners utilizing XML notification, the registry delivers an XML formatted message, as shown in FIG. 11, including a set of data fields defining the notification. Notification via such XML messages allows such subscribers to develop or obtain a custom interface designed to integrate the receipt of XML messages with their pre-existing data management systems and to automate processing of incoming messages.

The authorization maintenance steps for processing a item notification in a work list of a demand-side user (proceeding from option block 219 of step 221) is depicted as option menu 232 of FIG. 3. Authorization maintenance is the process of changing the authorization status of a item. Authorization of the product by a demand-side user initiates an expression of interest in an item. The first authorization maintenance event occurs for a product after the demand-side user is notified of the item. Specifically, a category manager receives notification of a new item and makes a decision to pre-authorize, authorize, pend, de-authorize, or reject the item, as shown at steps 236, 238, 240, 244, or 242, respectively. To pend means to hold for later processing, to reject means that there is no interest in the item, and to authorize means that there is interest in synchronizing data pertaining to the item. Pre-authorization indicates that the demand user intends to initiate the process of synchronizing all the in-house related systems to accept the item (e.g., accounts payable, merchandise management system, and the warehouse management system). Once these updates are complete, the user may issue an authorization message to indicate that the demand-side user has synchronized all of his systems. De-authorize indicates that the demand-side user no longer is interested in receiving further updates in order to maintain synchronization of the item.

It may occur that certain demand-side users require further information beyond that provided in the publication data discussed above. For example, particular retailers may require data particular to a product before they order and stock such a product. Alternatively, some retailers may require extended information for all items for which they desire to maintain synchronization. In order to provide exchange of such extended data without unduly complicating the publication or item maintenance functions, there is provided within the registration database a global data dictionary 19, which provides standard terms for specifying various types of data beyond those provided in the publication or item maintenance functions. In response to receiving a publication of interest for which the requisite extended data was not received, a demand-side partner may maintain an XML schema specifying items within the global data dictionary which are required prior to authorization of an item. Upon receipt of this schema, the supply-side partner may then enter the requisite data for transmission to the demand-side partner. Extended data may be included in an initial publication of an item record, if the supply-side partner is familiar with the extended data requirements of the recipients of the publication. In contrast to the basic item data discussed previously, the extended data portions of item records containing extended data is not checked against any registry compliance rules, and is not processed by recipients who do not require extended data which may be included in a received publication.

After the user has processed each item in the worklist or, alternatively, after all items have been processed, the user interface proceeds to step 246 in which notification of the user action is transmitted back to the registry for placement in an appropriate message queue for the corresponding supply-side partner(s). These notifications are subsequently delivered to the appropriate supply-side partner(s) and added to their worklist(s). Proceeding from option block 234 of step 221, a supply-side partner may review such notifications in step 237 in order to take appropriate action in response thereto. While not constituting a contract execution mechanism, the notifications received by the supply-side partner(s) provide expressions of interest or disinterest by which the supply-side partner may take appropriate further action for commercial engagements.

If the supply and demand partners utilize EDIINT-capable systems, then the parties to an authorization transaction may subsequently retrieve the EDIINT parameters, such as transport and encryption data, from the respective EDIINT records associated with their profiles. Having obtained the EDIINT data, the parties may then proceed toward independently conducting a commercial transaction utilizing the EDIINT protocol based on prior communications conducted via the system.

An alternative method of proceeding toward a commercial transaction is for the supply-side partner to provide pricing data to the demand-side partner via the XML document exchange functions provided by the system. In order to exchange pricing information after an item has been authorized, a supply-side partner maintains a set of pricing documents 31 at the trading partner's server 30. The manner in which these documents are exchanged by users may depend upon the nature of the relationship between the partners. A first document, a pricing bracket document, may associate general ranges of prices at which an item may be available within defined volume ranges and defined shipping conditions, such as distance. For demand partners having an established relationship, a price document may be maintained by the supply-side partner which specifies, for each established supply-side partner, the specific price each bracket at which the item is available to the demand-side partner. A third document, a payment term document, defines the payment terms required by the supply-side partner, and is usually specific to the demand-side partner. A fourth document, an allowance document, defines allowances which may be available relative to the price of the item under defined conditions. For established trading partner relationships, the supply side partner may configure the local server 30 to automatically provide one or more of these documents to a demand-side partner who has authorized an item. Otherwise, any or all of the pricing documents may be selectively sent by the supply-side partner in response to receiving an authorization message. In addition to these documents, a demand-side partner may maintain a price lead time document, which may be appended to an authorization message, and which defines the lead time required by the demand-side partner during which any price information must remain valid in order for the demand-side partner to purchase an item in the future.

The terms and expressions used herein are intended as terms of description, and not of limitation, and there is no intent by the use of such terms to exclude equivalents thereof from the scope of the invention as defined by reference to the appended claims.

we claim:

1. A method of collecting and distributing commercial data among commercial trading partner organizations, comprising the steps of:
establishing a registry database for containing:
user records defining contact information pertaining to respective suppliers and purchasers,
item records defining goods or services offered by the suppliers, and
subscription records defining goods or services of interest to purchasers,
assigning a unique location identification code to each functional unit within a trading partner organization defined within said user records;
connecting the registry database with a data communication network;
connecting a local processing adapter to the data communication network at a user location,
receiving item records from users and storing them within the registry;
matching received item records with subscription records defining events of interest selected by the users;
transmitting notifications of item records from the registry to the local processing adapter on the basis of said matching step.

2. The method of claim 1 wherein said transmitting step comprises the steps of:
maintaining a message queue for each user;
adding an item to each message queue on the basis of said matching step; and
transmitting said notifications to the user upon connection to the database on the basis of items contained in the user's message queue.

3. A method of collecting and distributing commercial data among commercial trading partner organizations including suppliers and purchasers, the method comprising the steps of:
establishing a registry database for containing:
user records defining contact information pertaining to respective suppliers and purchasers,
item records defining goods or services offered by the suppliers, and
subscription records defining goods or services of interest to purchasers,
storing EDI transport data associated with trading partner organizations;
connecting the registry database with a data communication network;
connecting a local processing adapter to the data communication network at a user location,
receiving item records from users and storing them within the registry;
matching received item records with subscription records defining events of interest selected by the users;
transmitting notifications of item records from the registry to the local processing adapter on the basis of said matching step;
receiving a message from a purchaser indicating an interest in an item in response to a transmitted notification to the purchaser;
further transmitting the respective stored EDI transport data to the supplier and purchaser, to enable the supplier and purchaser to engage in an EDI transaction pertaining to the item.

4. A method for exchanging data among trading partners including purchasers and suppliers, the method comprising steps of:
providing a registry database for containing item records pertaining to items offered for sale by the suppliers;
establishing subscription records among the purchasers, by which the purchasers specify attributes of items of interest;
providing access to the database by suppliers, to enable suppliers to establish or modify item records in the database;
notifying purchasers when an item of interest has been added or modified in the database, in accordance with the purchaser's subscription records.

5. The method of claim 4, further comprising steps of:
a supplier maintaining pricing data for an item external to the database;
transmitting a request from a purchaser to a supplier to provide pricing information for an item about which a purchaser has received a notification; and
transmitting said pricing data from said supplier to said purchaser in response to said request.

6. The method of claim 5 wherein the step of maintaining said pricing data comprises the step of establishing a pricing bracket record defining ranges of prices available for defined purchase conditions.

7. The method of claim 6 wherein the step of maintaining said pricing data further comprises the step of establishing a payment term record defining payment terms pertaining to the item.

8. The method of claim 7 wherein the step of maintaining said pricing data further comprises the step of establishing a price record specific to a purchaser, and setting a price for the item in accordance with a pre-established relationship between the supplier and the purchaser.

9. The method of claim 4 comprising the step of providing each item record as an XML document having defined data fields for entry of a predetermined set of attributes of the item.

10. The method of claim 9 comprising the step of providing a data dictionary at the registry for defining extended data fields within an item record, whereby additional attributes may be included in an item record.
